(19) United States
(12) Patent Application Publication
(10) Pub. No.: US 2011/0159403 A1
(43) Pub. Date: Jun. 30, 2011

(54) Layered Catalyst Assembly and Electrode Assembly Employing the Same

(75) Inventor: Mohan Karulkar, Dearborn, MI (US)

(73) Assignee: FORD GLOBAL TECHNOLOGIES, LLC, Dearborn, MI (US)

(21) Appl. No.: 12/715,592

(22) Filed: Mar. 2, 2010

(51) Int. Cl. H01M 4/92; H01M 4/02; B01J 21/18; H01M 8/10; B01J 23/42

(52) U.S. Cl. 429/487; 429/523; 429/524; 502/185

(57) ABSTRACT

According to one aspect of the present invention, a catalyst assembly is provided for use in a fuel cell. In one embodiment, the catalyst assembly includes a first layer containing a first noble metal catalyst supported on a first support material having a first average surface area, and a second layer containing a second noble metal catalyst supported on a second support material having a second average surface area less than the first average surface area. In another embodiment, the catalyst assembly is disposed next to an ionic exchange membrane, wherein the first layer is positioned between the first layer and the ionic exchange membrane. In yet another embodiment, the first and second support materials collectively define channels of differential hydrophobicity.

### BACKGROUND

1. Technical Field

One or more embodiments of the present invention relate to a layered catalyst assembly and an electrode assembly employing the same.

2. Background Art

A fuel cell generally includes two electrodes, an anode and a cathode, separated by an electrolyte. The electrodes are electrically connected through an external circuit, with a resistance load lying in between them. Solid polymer electrochemical fuel cells in particular employ a membrane electrode assembly (MEA) containing a solid polymer electrolyte membrane (PEM), also known as a proton exchange membrane, in contact with the two electrodes.

Polymer Electrolyte Membrane (PEM) fuel cells require certain water balance to provide efficient performance, including relatively high proton mobility and low occurrence of flooding. For instance, excess water can lead to flooding and hence reduced oxygen diffusion at the surface of the catalyst coated membrane (CCM). Excess water can also contribute to carbon corrosion in the catalyst. On the other side of the spectrum, insufficient water can cause drying of the catalyst layer, which may lead to slow start-up times, poor conductivity in the CCM, shortened membrane life, and/or overall performance loss.

### SUMMARY

According to at least one aspect of the present invention, a catalyst assembly is provided. In one embodiment, the catalyst assembly includes a first layer containing a first noble metal catalyst supported on a first support material having a first average surface area, and a second layer containing a second noble metal catalyst supported on a second support material having a second average surface area less than the first average surface area. In another embodiment, the catalyst assembly is disposed next to an ionic exchange membrane, wherein the first layer is positioned between the ionic exchange membrane and the second layer. In yet another embodiment, the first and second support materials collectively define channels of differential hydrophobicity.

In another embodiment, the channels of differential hydrophobicity include a relatively hydrophilic channel for passing water molecules and a relatively hydrophobic channel for passing oxygen molecules.

In yet another embodiment, the first and second support materials both include carbon black. In certain instances, the first average surface area of the first support material containing carbon black is from 300 to 2,300 square meters per gram (m²/g). In certain other instances, the second average surface area of the second support material containing carbon black is from 10 to 900 square meters per gram (m²/g).

In yet another embodiment, the first and the second noble metal catalysts each independently include a noble metal, a metallic alloy having at least one noble metal, or combinations thereof. In certain instances, one of the first and second noble metal catalysts includes platinum and the other includes a metallic alloy containing platinum. In certain other instances, the metallic alloy is a metallic alloy of platinum, nickel, and cobalt.

According to another aspect of the present invention, an electrode assembly is provided for use in a fuel cell. In one embodiment, the electrode assembly includes a substrate and a layered catalyst assembly as described herein. In certain instances, the electrode assembly is for use as a membrane electrode assembly, wherein the substrate is an ionic exchange membrane. In certain other instances, the electrode assembly is for use as a gas diffusion layer, wherein the substrate is a gas diffusion substrate.

According to yet another aspect of the present invention, a fuel cell is provided. In one embodiment, the fuel cell includes an ionic exchange membrane and a layered catalyst assembly described herein, wherein the layered catalyst assembly is disposed next to the ionic exchange membrane.

### BRIEF DESCRIPTION OF THE DRAWINGS

FIG. 1 depicts a cross-section of a membrane electrode assembly according to one embodiment of the present invention;

FIG. 2 depicts improved ECA (electrochemically active area) stability of the membrane electrode assembly (MEA) of FIG. 1 as compared to a conventional MEA structure; and

FIG. 3 depicts an exemplary fuel cell.

### DETAILED DESCRIPTION

Reference will now be made in detail to compositions, embodiments, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

As a component to a fuel cell adapted for use in a mobile vehicle, catalysts for both the anode and cathode electrodes have been increasingly investigated in automobile research and development for improved cell power generation.

Operation of fuel cells is often confronted with technical difficulties and challenges. For instance, inadequate water management at the cathode may cause flooding, a situation that may worsen in response to various parameters. Some of the parameters include increased electrode thickness, decreased proton transport, and uncoupled water removal. In particular situations, cathode flooding occurs when water production at the oxygen reduction reaction and electro-osmotic drag of water to the cathode exceed the water removal rate resulting from air based advection, evaporation, and/or back diffusion. Liquid water that builds up at a fuel cell cathode decreases performance and inhibits robust operation. Flooding in the cathode reduces oxygen transport to reaction sites and decreases the effective catalyst area. Cathode flooding can result in a significant decrease of performance.

Therefore, water management is an important issue concerning the long-term viability of proton exchange membrane fuel cells (PEMFCs) for application in the automobile industry. Fuel cells such as PEMFCs require a balanced water content to provide efficient performance including improved proton mobility and reduced flooding. Excess water can lead to flooding at the surface of the catalyst coated membrane (CCM) and prevent oxygen diffusion to the CCM surface. Insufficient water can cause drying of the catalyst layer, leading to slow start-up times, poor conductivity in the membrane, shortened membrane life, and overall performance loss.

It has been discovered that a layered catalyst assembly according to one or more embodiments of the present invention can be used to provide increased electrochemical performance with reduced ECA loss in a relatively corrosive environment such as in a fuel cell application. Without being limited to any particular theory, one possible explanation for the improved electrochemical performance realized with the use of the layered catalyst assembly is due to the effective control of water management in the fuel cell, particularly at the fuel cell membrane surface. It has further been found that water balance in an electrochemical device including a fuel cell can be effectively managed by providing layers of differential hydrophobicity in the layered catalyst assembly and electrode assembly employing the same according to certain other embodiments of the present invention. As water management is akin to the fuel cell environment, the layered catalyst assembly can provide reduced flooding, increased proton conductivity, and decreased ECA loss over time.

According to one or more embodiments of the present invention, the term “differential hydrophobicity” may refer to first and second regions/channels of the layered catalyst assembly, in which the first regions/channels have a relatively higher affinity for molecules such as water and thus facilitate transport of the water molecules, and the second regions/channels have a relatively higher affinity for molecules such as oxygen and thus facilitate transport of oxygen molecules. As a result, flow of water and flow of oxygen in a fuel cell compartment can be managed and flooding can be effectively controlled. For the purpose of illustration, an exemplary fuel cell 320 is schematically depicted in FIG. 3. The fuel cell 320 includes a pair of bi-polar plates 322 and 324 having grooves 326 and 328 formed at a predetermined interval on both sides of each of the bi-polar plates 322 and 324. The fuel cell 320 also includes an ionic exchange membrane 334 disposed between the bi-polar plates 322 and 324, a first electrode such as an air electrode 332 disposed between the ionic exchange membrane 334 and the bi-polar plate 324, and a second electrode such as a fuel electrode 330 disposed between the ionic exchange membrane 334 and the bi-polar plate 322.

The bi-polar plates 322 and 324 are for electrically connecting the air electrode 332 and the fuel electrode 330, and preventing fuel and air (an oxidizer) from being mixed. The grooves 326 and 328 are used as fuel and air passages in the cells connected end to end.

In operation, air is brought into contact with the air electrode 332, while at the same time, hydrogen gas is brought into contact with the fuel electrode 330 as fuel, which results in separation of the hydrogen gas into hydrogen ions and electrons on the fuel electrode 330. These hydrogen ions are combined with water to move to the air electrode 332 side in the ionic exchange membrane 334, while the electrons move via on external circuit (not shown) to the air electrode 332 side. In the air electrode 332, oxygen, electrons, and hydrogen ions react to generate water.

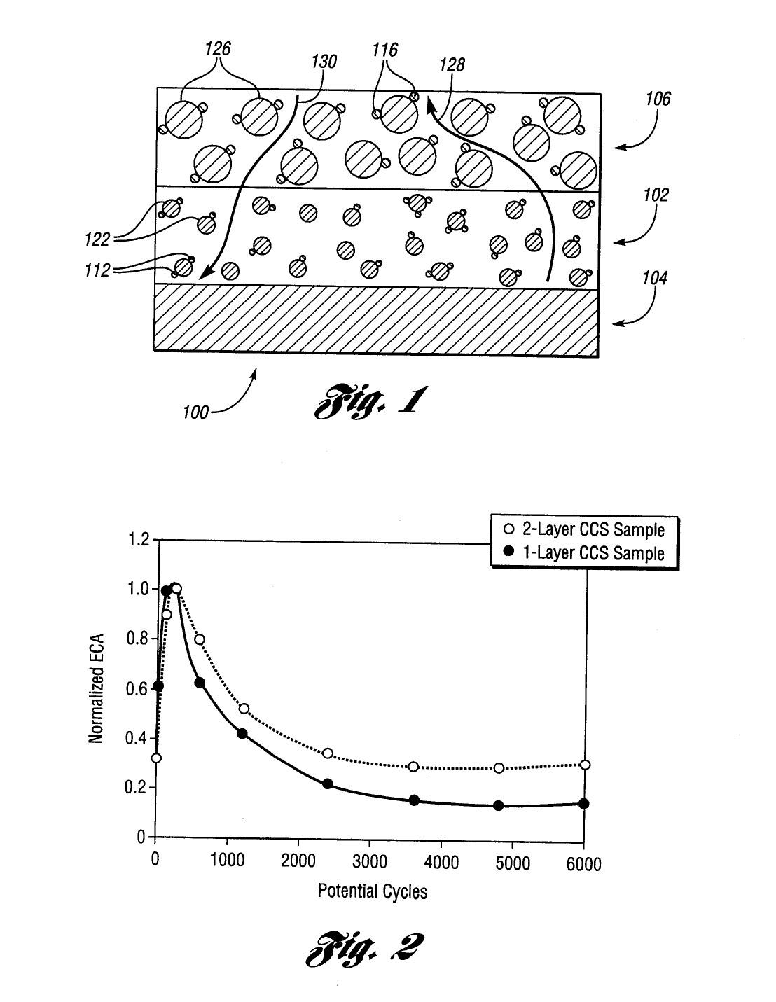

According to one aspect of the present invention, and as depicted in FIG. 1, an electrode assembly generally shown at 100 is provided for use in an electrochemical device such as a fuel cell of FIG. 3. The electrode assembly 100 can be used as a fuel electrode such as the fuel electrode 330 of FIG. 3 or used as an air electrode such as the air electrode 332 of FIG. 3. For illustration purposes, the electrode assembly 100 includes a substrate 104 such as an ionic exchange membrane, a first layer 102 and a second layer 106 wherein the first layer 102 is disposed between the substrate 104 and the second layer 106.

Although some of the embodiments described herein are directed to a two-layer configuration as shown in FIG. 1, it is still within the spirit of the present invention to configure the electrode assembly 100 to include additional catalyst layers and/or to have each of the layers 102, 106 include one or more sub-layers.

Referring back to FIG. 1, the first layer 102 includes a first noble metal catalyst 112 supported on a first support material 122; the second layer 106 includes a second noble metal catalyst 116 supported on a second support material 126. The first support material 122 is provided with a first average surface area that is different from a second average surface area provided to the second support material 126. The first and second average surface areas are based on the BET (Brunauer Emmett Teller) theory or method. It is believed that materials such as carbon black can offer differential hydrophobicity when configured to have different surface area. As will be described in more detail herein below, the differential hydrophobicity strategically provided to the layered catalyst assembly 100 affords a synergistic enhancement in tolerance to water accumulation and improvement in cost efficiency.

In yet another embodiment, the first average surface area of the first support material 122, optionally containing carbon black, is from 300 m²/g to 2,300 m²/g, 600 m²/g to 2,300 m²/g, or 900 m²/g to 2,300 m²/g (square meters per gram) dry weight of the first support material.

In yet another embodiment, the second average surface area of the second support material 126, optionally containing carbon black, is from 10 m²/g to 900 m²/g, 10 m²/g to 600 m²/g, 10 m²/g to 900 m²/g (square meters per gram) dry weight of the first support material.

In yet another embodiment, and as depicted in FIG. 1, the layered catalyst assembly 100 is provided with channels of differential hydrophobicity, illustratively including at least one channel 128 having increasing hydrophilicity, in the direction of arrow shown, for passing water molecules and at least one channel 130 having increasing hydrophobicity, in the direction of arrow shown, for passing oxygen molecules.

It has also been found the layered catalyst assembly 100 according to certain embodiments of the present invention, when used in a fuel cell application, is configured to increase voltage-current performance and reduce ECA loss of the fuel cell. Therefore, the layered catalyst assembly 100 is further defined over conventional catalysts having catalyst metals supported on a material having uniform surface area.

As used herein in one or more embodiments, the term “current density” refers to an amount of electric current in unit of ampere(s) per square centimeter of a planar surface of the fuel cell in which the catalyst is adapted to be used. An example of the planar surface includes the air electrode 332 and the fuel electrode 330 as depicted in FIG. 3.

The first and the second support materials 112, 116 may each independently include one or more of the following materials: carbon, such as carbon black of various particles sizes, mesoporous carbons and carbon gels; carbides formed of carbon and a less electronegative element; and inorganic metal oxides, such as titanium-based oxides, tin-based oxides, tunsgen-based oxides, ruthenium-based oxides, zirconia-based oxides, silicon-based oxides, indium tin-based oxides. An article by E. Antolini and E. R. Gonzalez, entitled “Ceramic materials as supports for low-temperature fuel cell catalysts,” published in Solid State Ionics 180 (2009) 746-763 provides a good list of these potential support materials. The entire contents of this article are incorporated herein by reference.

In certain embodiments, the first and the second support materials 112, 116 each independently include carbon black. When used as the support material, carbon black can be configured to have different surface area and hence differential hydrophobicity for use in a fuel cell environment. Carbon blacks can be configured to have various particles sizes, with relatively bigger particles sizes per a given weight generally indicating a relatively lower surface area. However, surface area measurements can be carried out using any suitable method. One method is pursuant to the BET theory.

By way of example, carbon black by the trade name of “Ketjenblack EC” can have a relatively high surface area value in the range of 800 to 1000 square meters per gram, or m²/g; whereas carbon black by the trade name of “Acetylene black” can have a relatively low surface area value in the range of 50 to 100 m²/g. A list of carbon blacks with corresponding surface area value is tabulated in Table 1.

TABLE 1
An illustrative list of carbon black materials
having various surface area

| Carbon Black | Average Surface Area |
|---|---|
| Material | (m²/g) |
| Black Pearls 2000 | 1500 |
| Ketjenblack EC | 930 |
| Vulcan XC-72 | 250 |
| Spheron C | 230 |
| Vulcan XC-72 | 180 |
| Ketjenblack HAF | 110 |
| Acetylene black | 65 |

In certain particular embodiments, the layered catalyst assembly 100 includes platinum as the first noble metal catalyst 112 supported on a relatively high surface area carbon backing as the first support material 122 and platinum or a platinum alloy as the second noble metal catalyst 116 supported on a relatively low surface area carbon backing as the second support material 126 to introduce layers of differential hydrophobicity and hence differential affinity for water or oxygen molecules. It is believed that areas represented by the relatively low surface area carbon backing are relatively hydrophilic, while areas represented by the relatively higher surface area carbon backing are relatively hydrophobic. As a result of this arrangement, and as indicated herein elsewhere, special pathways are formed between the layers 102, 106 of the layered catalyst assembly 100 that particularly favor water transport. The differential hydrophobicity creates areas of varying wetness along an axis with arrow shown, allowing clear “pathways” for oxygen to diffuse (hydrophobic) and water to exit. This is in contrast to a traditional catalyst mixture, which has homogenous hydrophobicity properties and wherein oxygen diffusion or water exit cannot be accommodated effectively. The use of mixed carbon with differing particle sizes and hence surface areas, for instance, represents a novel approach to creating areas of differential hydrophobicity within the layered catalyst assembly 100.

The noble metal used in the first and the second noble metal catalysts 112, 116 illustratively includes platinum (Pt), ruthenium (Ru), palladium (Pd), rhodium (Rh), iridium (Ir), gold (Au), silver (Ag), alloys thereof, or combinations thereof. The first and the second noble metal catalysts can also include metallic alloys containing one or more noble metals. The metallic alloys may take the form of binary, ternary, or quaternary alloys. The non-noble metal alloy elements, when used in the metallic alloys, can include but not restricted to Groups IIIb, IVb, Vb, VIb, VIIb, VIIIb, IXb, Xb, and XIb, with illustrative examples including cobalt (Co), chromium (Cr), tin (Sn), tungsten (W), iron (Fe), nickel (Ni), thorium (Th), aluminum (Al), iridium (Ir), rhodium (Rh), gold (Au), ruthenium (Ru), copper (Cu), manganese (Mn), lead (Pb), molybdenum (Mo), and palladium (Pd).

The metallic alloy, according to one or more embodiments of the present invention, refers to a mixture of metals wherein at least one component metal presents crystal structure that differs from respective original structure of the metal in its pure metal form.

Any suitable methods may be employed to construct the first and second layers 102, 106 without having to deviate from the general spirit of the present invention. For instance, the first layer 102 and the second layer 106 can be sequentially applied onto the membrane 104 by decal method to form a catalyst coated membrane (CCM). Catalyst ink is coated on a smooth surface, such as Kapton or Teflon film by doctor-blading, air brushing, screen printing, and/or deskjet/laser printing. When any one of the layers 102, 106 is configured to be formed of two or more catalyst sub-layers, the sub-layers can be applied in series, applying the first layer and repeating the steps for the second layer. Different coating processes can also be utilized to form multiple layers, such as first layer can be applied by screen printing and second layer applied by air brushing.

Alternatively, the first and second layers 102, 106 can also be applied directly on the gas diffusion layer substrate by decal method to form a catalyst coated substrate (CCS). Catalyst ink is coated on a smooth surface, such as Kapton or Teflon film by doctor-blading, air brushing, screen printing, and/or deskjet/laser printing. When applicable, the layers 102, 106 can be applied in 2-step in series, applying the first layer 102 and then repeating the steps for the second layer 106. Different coating processes can also be utilized to form multiple layers, such as first layer can be applied by screen printing and second layer applied by air brushing.

The ionic exchange membrane 104 as depicted in FIG. 1 may be sulfonic acid group-containing polystyrenic cation exchange membranes used as cationic conductive membranes, and fluorine-containing ion exchange resin membranes, typically membranes made of a mixture of a fluorocarbonsulfonic acid and polyvinylidene fluoride, membranes produced by grafting trifluoroethylene onto a fluorocarbon matrix, and perfluorosulfonic acid resin membranes. An illustrative example for the solid polyelectrolyte membrane is Nafion® membranes made by DuPont.

According to certain particular embodiments, the layered catalyst assembly 100 includes platinum on a relatively high surface area carbon material as the first support material 122 and platinum or a platinum alloy on a relatively low surface area carbon material as the second support material 126, with differential hydrophobicity introduced into the layered catalyst assembly 100 that favors water molecules being pulled away from the substrate 104. For these particular embodiments, a layer of platinum on high surface area carbon is applied first, followed by a layer of platinum on a relatively low surface area carbon; catalyst metal on low surface area (SA) carbon-backing is relatively hydrophilic, while catalyst metal on high SA carbon-backing is relatively hydrophobic. This arrangement has the effect of “pulling” water away from the catalyst/membrane interface where it is generated, and is in contrast to a traditional catalyst mixture, which has homogenous hydrophobicity properties and does not induce preferential water flow.

While the electrode assemblies having the layered catalyst assembly 100 have been discussed herein within the context of an ionic exchange membrane fuel cell, the scope of the invention is not so limited. Rather, the membrane electrode assemblies with catalyst layers of the present invention can be used for improved power per dollar return in any electrochemical cell requiring a catalyst layer on the surface of an electrode. For instance, the membrane electrode assemblies with catalyst layers can be utilized in electrocatalytic oxidation (ECO) cells. ECO cells utilize the typical structure of a standard ionic exchange membrane fuel cell, but act as a system to remove excess carbon monoxide (CO) from the fuel cell feed stream.

Having generally described this invention, a further understanding can be obtained by reference to certain specific examples which are provided herein for purposes of illustration only and are not intended to be limiting unless otherwise specified.

### EXAMPLE

Two catalyst-coated substrate (CCS) samples on TORAY Carbon Payer (EC-TP1-060) are prepared. One CCS sample is configured as a 1-layer format including Pt on high surface area (SA) carbon. The other CCS sample is configured as a 2-layer format including an inner layer having platinum (Pt) on high SA carbon backing and an outer layer having Pt on low SA carbon (C) backing.

The catalyst mixtures for the CCS samples are prepared as follows. For the 1-layer CCS, catalyst ink is prepared by suspending Pt/C (Cabot Corp, Dynalyst 50K R1 50% Pt on High SA Ketjenblack) in dionized water and combining with Nafion (0.4 Nafion:Pt) and Teflon (0.035 Teflon:Pt) solutions. For the 2-layer CCS, catalyst ink for Pt on high SA carbon backing is mixed as above. The catalyst ink for Pt on low-SA carbon backing is prepared by suspending Pt/C (ETEK, 20% Pt on Low SA Vulcan XC-72) in dionized water and combining with Nafion (0.4 Nafion:Pt) and Teflon (0.035 Teflon:Pt) solutions.

Catalyst powders are suspended in water and combined with ElectroChem Inc. Nafion 5% Solution (EC-NS-05-AQ) and ElectroChem Inc. Teflon Emulsion Solution (EC-TFE-500 ml) in the proportions indicated above. Trace Al(NO₃)₃ is also added to the ink solution, leading to slight agglomeration, which is believed to aid in filtration/drainage. The solution is mixed via ultrasonic bath for 2 minutes after each component is added.

The catalyst ink mixtures are filtered through Crepe Exam Table Paper using a 24 cm² Buchner funnel. No vacuum is applied, and filtration/drainage takes 1.5 hours. After drainage is complete, a moist layer of catalyst slurry is left on the crepe paper, approximately 1mm thick.

For the 1-layer CCS sample, the filter paper is removed and applied face-down to one side of a 625 cm² sheet of ElectroChem Inc. TORAY Carbon Paper (EC-TP1-060). The crepe paper and carbon paper assembly is pressed for 5 minutes (Carver Hot Press, Model 4122) at room temperature and with 1800 lbs. After the pressing, the crepe paper is peeled off, leaving the 24 cm² Pt/C layer on carbon paper.

For the 2-layer CCS sample, the filter paper with Pt on high SA carbon backing is removed and applied face-down to one side of a 625 cm² sheet of ElectroChem Inc. TORAY Carbon Paper (EC-TP1-060). The crepe paper and carbon paper assembly is then pressed (Carver Hot Press, Model 4122) at room temperature and with 1800 lbs for 5 minutes. After the pressing, the crepe paper is peeled off, leaving the 24 cm² Pt/C layer on carbon paper. The filter paper with Pt on low SA carbon backing is removed and applied face-down on top of the previously-pressed layer of Pt on high SA carbon backing. The pressing/peeling procedure is repeated to produce the 2-layer CCS.

The CCS samples are dried in a vacuum oven overnight at 140° C., cooled and then cut into 1 cm² squares, to be used as electrodes for comparative ECA retention testing.

The 2-layer CCS sample is applied to a Toray graphite electrode rather than in a CCM, in order to perform accelerated corrosion testing, but the hydrophobicity characteristics are analogous to use in CCMs.

As illustratively shown in FIG. 1, the first layer 102 is a relatively hydrophobic catalyst layer which is disposed next to the membrane 104 and repels water, while the second layer 106 is a relatively hydrophilic layer that attracts water, together, a channel 128 is formed in the direction shown to “pull” water molecules away from the surface of the electrolyte membrane 104. The gradient can be reversed by switching the layers, or further refined by using additional layers.

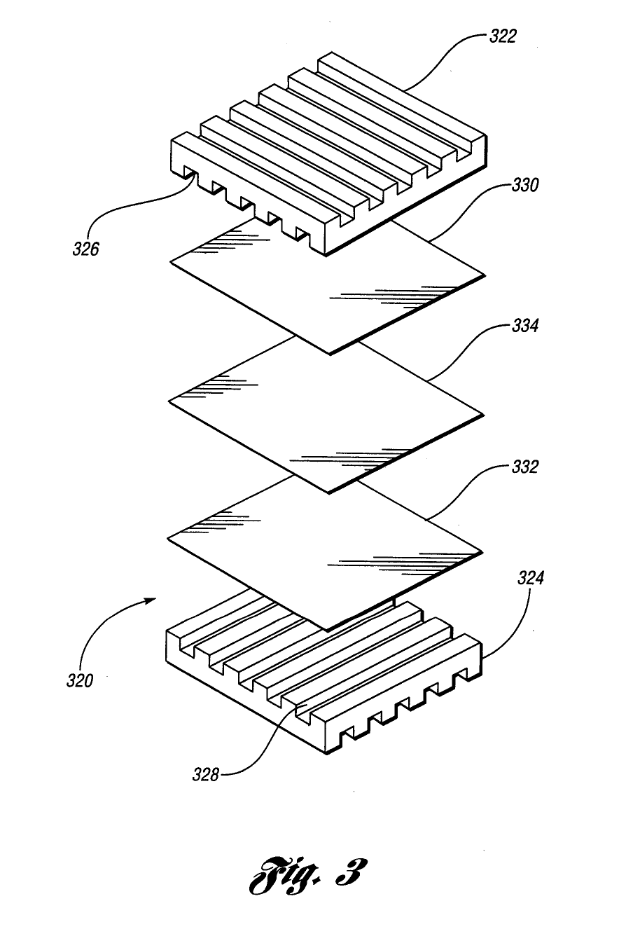

FIG. 2 shows ECA loss compared between non-hybrid Pt on high surface area carbon sample and for 2-layer hybrid catalyst sample. The 2-layer hybrid catalyst sample consists of a layer of Pt on high surface area C coated on a Toray substrate, with a layer of Pt on low surface area C above that, according to one embodiment of the present invention. The non-hybrid “high performance” catalyst sample includes Pt on high surface area ketjenblack. The 2-layer hybrid catalyst sample includes high-SA C (Pt on high surface area ketjenblack) for the inner layer and low-SA C (Pt on low surface area Vulcan XC-72) for the outer layer, as per FIG. 1. Both CCS samples have the same Pt and carbon loading. The results show that the 2-layer hybrid catalyst sample displays lower ECA loss over the course of potential cycling—about 15% less after 6000 potential cycles. Thus, by using a 2-layer hybrid catalyst to promote water movement out of the catalyst region, one can achieve more effective water management, lessen the effects of ECA loss, and, consequently, improve catalyst performance.

As can be observed from the FIGS. 1 and 2 described above, the 2-layer hybrid catalyst sample elicits relatively better ECA retention during corrosion testing as compared to the 1-layer catalyst sample. Without being limited to any particular theory, one possible reason for the observed better electrochemical performance of the 2-layer hybrid catalyst sample is believed to be because 2-layer hybrid catalyst has better control over the flow of water near the catalyst/membrane interface by introducing differential hydrophobicity of between the layers and hence creating hydrophobicity/hydrophilicity gradients to improve water management. Improved water management leads to enhanced ECA retention during corrosion testing. These benefits contribute to the overarching goal of decreasing platinum loadings in fuel cell applications while maintaining or improving performance.

While the best mode for carrying out the invention has been described in detail, those familiar with the art to which this invention relates will recognize various alternative designs and embodiments for practicing the invention as defined by the following claims.

What is claimed:

1. A catalyst assembly comprising:
a first layer containing a first noble metal catalyst supported on a first support material having a first average surface area; and
a second layer containing a second noble metal catalyst supported on a second support material having a second average surface area less than the first average surface area.

2. The catalyst assembly of claim 1, wherein the first and second support materials collectively defining channels of differential hydrophobicity, the channels of differential hydrophobicity including at least one channel with increasing hydrophilicity along a longitudinal axis for passing water molecules and at least one channel with increasing hydrophobicity along a longitudinal axis for passing oxygen molecules.

3. The catalyst assembly of claim 1, wherein the first and second support materials both include carbon black.

4. The catalyst assembly of claim 1 to be disposed next to an ionic exchange membrane, wherein the first layer is positioned between the second layer and the ionic exchange membrane.

5. The catalyst assembly of claim 4, wherein the first average surface area of the first support material containing carbon black is from 300 to 2,300 square meters per gram (m²/g), and the second average surface area of the second support material containing carbon black is from 10 to 900 square meters per gram (m²/g).

6. The catalyst assembly of claim 1, wherein the first and the second noble metal catalysts each independently include a noble metal, a metallic alloy having at least one noble metal, or combinations thereof.

7. The catalyst assembly of claim 6, wherein one of the first and second noble metal catalysts includes platinum and the other includes a metallic alloy of platinum, nickel, and cobalt.

8. The catalyst assembly of claim 1, wherein the first layer contains platinum as the first noble metal catalyst supported on carbon black as the first support material having a first average carbon black surface area, and wherein the second layer contains platinum as the second noble metal catalyst supported on carbon black as the second support material having a second average carbon black surface area less than the first average carbon black surface area.

9. An electrode assembly for use in a fuel cell, comprising:
a substrate; and
a layered catalyst assembly disposed next to the substrate, the layered catalyst assembly including a first layer containing a first noble metal catalyst supported on a first support material having a first average surface area;
and a second layer disposed next to the first layer, the second layer containing a second noble metal catalyst supported on a second support material having a second average surface area less than the first average surface area, wherein the first layer is disposed between the substrate and the second layer, and wherein the first and second support materials collectively defining channels of differential hydrophobicity.

10. The electrode assembly of claim 9, wherein the channels of differential hydrophobicity including a relatively hydrophilic channel for passing water molecules and a relatively hydrophobic channel for passing oxygen molecules.

11. The electrode assembly of claim 9 for use as a membrane electrode assembly, wherein the substrate is an ionic exchange membrane.

12. The electrode assembly of claim 9 for use as a gas diffusion layer, wherein the substrate is a gas diffusion substrate.

13. The electrode assembly of claim 9, wherein the first and second support materials of the layered catalyst assembly both include carbon black.

14. The electrode assembly of claim 13, wherein the first average surface area of the first support material containing carbon black is from 300 to 2,300 square meters per gram (m²/g).

15. The electrode assembly of claim 14, wherein the second average surface area of the second support material containing carbon black is from 10 to 900 square meters per gram (m²/g).

16. The electrode assembly of claim 9, wherein the first and the second noble metal catalysts each independently include a noble metal, a metallic alloy having at least one noble metal, or combinations thereof.

17. The electrode assembly of claim 15, wherein one of the first and second noble metal catalysts includes platinum and the other includes a metallic alloy of platinum, nickel, and cobalt.

18. A fuel cell comprising:
an ionic exchange membrane; and
a layered catalyst assembly disposed next to the ionic exchange membrane, the layered catalyst assembly including a first layer containing a first noble metal catalyst supported on a first support material having a first average surface area; and a second layer disposed next to the first layer, the second layer containing a second noble metal catalyst supported on a second support material having a second average surface area less than the first average surface area, wherein the first layer is disposed between the substrate and the second layer, and wherein the first and second support materials collectively defining channels of differential hydrophobicity, and wherein the channels of differential hydrophobicity including a relatively hydrophilic channel for passing water molecules and a relatively hydrophobic channel for passing oxygen molecules.

19. The fuel cell of claim 18, wherein the first and second support materials of the catalyst both include carbon black, wherein the first average surface area of the first support material containing carbon black is from 300 to 2,300 square meters per gram (m²/g), and wherein the second average surface area of the second support material containing carbon black is from 10 to 900 square meters per gram (m²/g).

20. The fuel cell of claim 19, wherein the first noble metal catalyst includes platinum and the second noble metal catalyst includes a metallic alloy of platinum, nickel, and cobalt.
